(19) United States
(12) Patent Application Publication
(10) Pub. No.: US 2017/0296975 A1
(43) Pub. Date: Oct. 19, 2017

(54) RAW WATER FILTRATION TREATMENT SYSTEM, AND METHOD FOR CLEANING FILTRATION DEVICE

(71) Applicant: MITSUBISHI HEAVY INDUSTRIES, LTD., Tokyo (JP)

(72) Inventors: Kiyoshi Tatsuhara, Tokyo (JP); Masayuki Tabata, Tokyo (JP)

(73) Assignee: MITSUBISHI HEAVY INDUSTRIES, LTD., Tokyo (JP)

(21) Appl. No.: 15/517,375

(22) PCT Filed: Oct. 10, 2014
(86) PCT No.: PCT/JP2014/077226

§ 371 Date: Apr. 6, 2017

(51) Int. Cl. B01D 65/02; B01D 61/02; B01D 61/14; C02F 1/44; C02F 1/00; C02F 103/08; C02F 101/30

(52) U.S. Cl. CPC B01D 65/02; C02F 1/442; B01D 61/027; B01D 61/145; C02F 1/008; C02F 1/441; C02F 1/444; B01D 61/025; B01D 2321/04; C02F 2101/30; C02F 2103/08; C02F 2209/11; C02F 2303/16

(57) ABSTRACT

A filtration treatment system of raw water includes a raw water supply line to supply raw water, a filtration device provided on the raw water supply line to filter impurities in the raw water, a separation device provided on a rear side of the filtration device and equipped with a separation membrane to separate filtered raw water into permeated water and concentrated water; an organic substance monitoring device provided on either front or rear or both front and rear of the filtration device to monitor an amount of an organic substance in the raw water, and a control device to execute backwashing of the filtration device with the permeated water as backwashing water in a case in which the amount of the organic substance in the raw water exceeds a reference value as a result of monitoring by the organic substance monitoring device.

### FIELD

The present invention relates to a filtration treatment system of raw water which desalinates, for example, seawater, and a method of washing a filtration device.

### BACKGROUND

In a desalination treatment system in which desalination is performed by using, for example, seawater as raw water, pretreatment of seawater to be supplied to the desalination treatment device is performed. As a filtration treatment device for this pretreatment, a filtration device to remove impurities is installed on the upstream side of the desalination treatment device. As this filtration device, for example, a filtration device (DMF: Dual Media Fileter) in which a plurality of granular filtration layers with silica sand, anthracite or the like are layered is used.

Turbidity causing materials (SS) and the like are removed by filtering seawater by using this filtration device. In the case in which water-soluble organic substances (biological polysaccharides and the like) are contained in seawater, water-soluble organic substances are also removed through adsorption to the surface of the filter medium installed in the filtration device and adsorption to the floc formed by, for example, a flocculant such as iron chloride.

However, the pressure loss increases due to clogging when the filter medium is contaminated by filtration, and in the related art, backwashing of the filtration device is thus regularly performed to remove dirt and to recover the performance.

Here, seawater (concentrated water concentrated by the desalination device) is usually used upon backwashing of the filtration device. Here, with regard to removal of turbidity causing materials in which inorganic substance are mostly composed, there is not a serious problem even when seawater is used since it is possible to remove the fine particles attached to the filter medium by peeling off them through a physical action such as an abrupt flow at the time of backwashing, or the like.

However, in the case of containing water-soluble organic substances in raw water, the adsorption amount of the water-soluble organic substances to the filter medium or the like to be adsorbed to the floc of iron chloride or the surface of the filter medium is determined so as to be in the adsorption equilibrium with the concentration thereof in the liquid in principle. Water-soluble organic substances to be the target of removal are originally present in seawater, and the adsorption amount thereof thus gradually increases along with the lapse of operation time and increases until it reaches the equilibrium adsorption amount with respect to the concentration thereof in seawater as long as seawater is used for backwashing.

In addition, at the time of operating the desalination treatment, the organic substances adsorbed to the flocs of iron chloride and the like are removed in advance on the upstream side to be introduced into the filtration device and the concentration of organic substances in seawater decreases, thus the organic substances adsorbed to the filter medium are contrarily desorbed at the time of backwashing and there is also a problem that the removal efficiency does not increase. In other words, a certain amount of water-soluble organic substances always remain as long as backwashing is performed by using seawater.

In view of the above, in the related art, it is proposed that it is effective to use fresh water that is permeated water manufactured by the desalination device instead of seawater (concentrated water) when performing backwashing in a case in which the pressure loss increases before and after the filtration device and clogging of the filter medium and the like are caused (Patent Literature 1).

### CITATION LIST

### Patent Literature

Patent Literature 1: Japanese Laid-open Patent Publication No. 61-274714

### SUMMARY

### Technical Problem

However, in the case of carrying out the backwashing proposed in Patent Literature 1, there is a problem that the yield of fresh water of the product decreases since a large amount of fresh water that is permeated water thus manufactured is consumed at the time of backwashing.

Accordingly, it is significantly desired to develop a method of washing a filtration device, which is capable of decreasing the amount of fresh water of the product used as much as possible when performing washing of the filtration device.

In view of the above problems, an object of the present invention is to provide a filtration treatment system of raw water and a method of washing a filtration device, which are capable of, for example, decreasing the amount of fresh water of the product used as much as possible when performing washing of the filtration device.

The first embodiment of the invention to solve the problem is a filtration treatment system of raw water including a raw water supply line that is configured to supply raw water, a filtration device that is provided on the raw water supply line and configured to filter impurities in the raw water, a separation device that is provided on a rear side of the filtration device and equipped with a separation membrane to separate filtered raw water into permeated water and concentrated water in which a solute including a salt or fine particles are enriched, an organic substance monitoring device that is provided on either front or rear or both front and rear of the filtration device and configured to monitor an amount of an organic substance in the raw water, and a control device that is configured to execute backwashing of the filtration device with the permeated water as backwashing water in a case in which the amount of the organic substance in the raw water is determined to exceed a reference value as a result of monitoring by the organic substance monitoring device.

According to the present invention, it is possible to efficiently perform recovery of the filtration performance by removing the organic substances of the filtration device while suppressing the amount of permeated water used since permeated water is not always used at the time of backwashing by using permeated water for backwashing in a case in which the amount of organic substances exceeds the reference value.

The second embodiment is the filtration treatment system of raw water according to the first embodiment, wherein the control device executes backwashing of the filtration device with the raw water or the concentrated water as the backwashing water in a case in which the amount of the organic substance in the raw water is determined to be equal to or less than the reference value as a result of monitoring by the organic substance monitoring device.

According to the present invention, it is possible to achieve a decrease in amount of permeated water used when carrying out backwashing by usually using raw water or concentrated water in a case in which the amount of organic substances in raw water is equal to less than the reference value and by using permeated water for backwashing in a case in which the amount of organic substances in raw water exceeds the reference value.

The third embodiment is a filtration treatment system of raw water including a raw water supply line that is configured to supply raw water, a filtration device that is provided on the raw water supply line and configured to filter impurities in the raw water, a separation device that is provided on a rear side of the filtration device and equipped with a separation membrane to separate filtered raw water into permeated water and concentrated water in which a solute including a salt or fine particles are enriched, an organic substance monitoring device that is provided on either front or rear or both front and rear of the filtration device and configured to monitor an amount of an organic substance in the raw water, and a control device that is configured to execute backwashing of the filtration device with the concentrated water as backwashing water in a case in which the amount of the organic substance in the raw water is determined to be equal to or less than a reference value as a result of monitoring by the organic substance monitoring device and execute backwashing of the filtration device with the permeated water as the backwashing water in a case in which the amount of the organic substance in raw water is determined to exceed the reference value as a result of monitoring by the organic substance monitoring device.

According to the present invention, it is possible to achieve a decrease in amount of permeated water used when carrying out backwashing by usually using concentrated water in a case in which the amount of organic substances in raw water is equal to less than the reference value and by using permeated water for backwashing in a case in which the amount of organic substances in raw water exceeds the reference value.

The fourth embodiment is the filtration treatment system of raw water according to any one of the first to third embodiments, wherein the organic substance monitoring device includes an organic substance concentration measurement device configured to measure a concentration of the organic substance in the raw water.

According to the present invention, it is possible to measure the confirmation of the amount of organic substances in the raw water by the concentration of organic substances.

The fifth embodiment is the filtration treatment system of raw water according to any one of the first to fourth embodiments, wherein the organic substance monitoring device is provided on a rear side of the filtration device and includes a turbidity measuring device configured to measure a turbidity in raw water from the filtration device.

According to the present invention, it is possible to perform the confirmation of the amount of organic substances in the raw water by a turbidity measuring device which measures the turbidity.

The sixths embodiment is the filtration treatment system of raw water according to any one of the first to fifth embodiments, wherein the control device executes backwashing of the filtration device with the permeated water at every set period.

According to the present invention, the organic substances on the filtration layer is removed and the accumulation of organic substances is suppressed by performing backwashing by using permeated water at every set period of time since the amount of organic substances adsorbed to the filtration layer of the filtration device gradually increases even in a case in which the amount of organic substances in the raw water does not remarkably increase.

The seventh embodiment of the invention is the filtration treatment system of raw water according to any one of the first to sixth embodiments, including a plurality of the separation devices, wherein the plurality of separation devices are connected to permeated water lines to discharge the permeated water in series, the filtration device is connected to a permeated water line of permeated water to be discharged from the separation device provided on an upstream side of the separation device at a final stage, and the control device performs backwashing of the filtration device with permeated water to be discharged from the separation device provided on the upstream side of the separation device at the final stage in a case of executing backwashing of the filtration device with the permeated water.

According to the present invention, in the case of improving the separation performance by installing the separation device equipped with a separation membrane to obtain permeated water at a plurality of stages and in series, it is possible to obtain a sufficient backwashing effect without significantly decreasing the treatment efficiency of the separation plant by using permeated water from a separation device that is provided on the upstream side of the separation device at the final stage and equipped with a separation membrane on the leading side having a relatively low separation rate instead of using permeated water from the separation device at the final stage as the permeated water to be used for backwashing.

The eights embodiment of the invention is the filtration treatment system of raw water according to any one of the first to seventh embodiments, wherein the filtration device includes filtration device main body that has a plurality of filtration layers layered in a vertical axis direction in an interior, a supply line that is configured to supply the raw water from a top portion side of the filtration device main body, a filtered raw water supply line that is configured to discharge filtered raw water filtered from a bottom portion side of the filtration device main body and supply the filtered raw water to the separation device, a backwashing water introduction line that is configured to introduce backwashing water from the bottom portion side of the filtration device main body, an overflow line that is configured to collect the backwashing water overflowed from a top portion side of the filtration layers of the filtration device main body, and a backwashing water discharge line that is configured to discharge the backwashing water of the filtration device main body from the bottom portion side of the filtration device main body.

According to the present invention, it is possible to decrease the concentration of organic substances in the washing water and to improve the washing effect when the interior of the filtration device is washed by once discharging the backwashing water contaminated with the organic substances in the filtration device.

The ninth embodiment of the invention is the filtration treatment system of raw water according to any one of the first to eighth embodiment, wherein the control device executes backwashing by carrying out a treatment in which the backwashing water discharge line is opened, the backwashing water in an interior of the filtration device main body is drained through the backwashing water discharge line, then the backwashing water discharge line is closed, and the backwashing water is introduced into the interior of the filtration device main body through the backwashing water introduction line at least once or more in a case in which the control device determines to execute backwashing of the filtration device.

According to the present invention, it is possible to decrease the concentration of organic substances in the washing water and to improve the washing effect when the interior of the filtration device is washed by draining the backwashing water remaining in the interior of the filtration device main body and then supplying backwashing water.

The tenth embodiment of the invention is the filtration treatment system of raw water according to any one of the first to ninth embodiments, wherein the control device executes backwashing with the permeated water after detecting that the concentration of the organic substance is decreased to a concentration equal to or less than a threshold concentration lower than a predetermined concentration in a case in which a state in which the concentration of the organic substance exceeds the predetermined concentration continues for a predetermined time or longer through monitoring by the organic substance monitoring device.

According to the present invention, the filtration layer of the filtration device is contaminated immediately after the operation is restarted after backwashing is performed and the backwashing operation is immediately required even if the backwashing operation is carried out in a state in which the concentration of organic substances in raw water is still high. Hence, it is possible to save the amount of permeated water used and to perform effective washing by continuously performing the operation as it is even though the concentration of organic substances in raw water exceeds a predetermined value and performing backwashing by using the permeated water after the concentration of organic substances in the raw water is decreased.

The eleventh embodiment of the invention is a method of washing a filtration device that removes a suspended solid in raw water, the method including an organic substance monitoring step of monitoring an amount of an organic substance in the raw water, and a permeated water backwashing step of backwashing the filtration device by using permeated water obtained by removing a solute including a salt or fine particles from the filtered raw water as backwashing water in a case in which an amount of an organic substance in the raw water monitored in the organic substance monitoring step exceeds a reference value.

According to the present invention, it is possible to efficiently perform recovery of the filtration performance by removing the organic substances of the filtration device while suppressing the amount of permeated water used since permeated water is not always used at the time of backwashing by using permeated water for backwashing in a case in which the amount of organic substances exceeds the reference value.

The twelfth embodiment is a method of washing a filtration device that is configured to remove a suspended solid in raw water, the method including an organic substance monitoring step of monitoring an amount of an organic substance in the raw water, and a step of performing backwashing of the filtration device by using concentrated water as backwashing water in a case in which an amount of an organic substance in the raw water monitored in the organic substance monitoring is determined to be equal to or less than a reference value and performing backwashing of the filtration device by using permeated water as the backwashing water in a case in which the amount of the organic substance in the raw water is determined to exceed the reference value as a result of monitoring by the organic substance monitoring device.

According to the present invention, it is possible to achieve a decrease in amount of permeated water used when carrying out backwashing by usually using concentrated water in a case in which the amount of organic substances in raw water is equal to or less than the reference value and by using permeated water for backwashing in a case in which the amount of organic substances in raw water exceeds the reference value. Advantageous Effects of Invention

According to the present invention, it is possible to efficiently perform recovery of the filtration performance by removing the organic substances of the filtration device while suppressing the amount of permeated water used since permeated water is not always used at the time of backwashing by using permeated water for backwashing in a case in which the amount of organic substances exceeds the reference value.

### BRIEF DESCRIPTION OF DRAWINGS

FIG. 1 is a schematic diagram of a desalination treatment system according to a first embodiment.

FIG. 2 is a schematic diagram of another desalination treatment system according to the first embodiment.

FIG. 3-1 is a diagram illustrating the relation of the pressure loss and the concentration of organic substances with the elapsed days.

FIG. 3-2 is a diagram illustrating the relation of the pressure loss and the concentration of organic substances with the elapsed days.

FIG. 3-3 is a diagram illustrating the relation of the pressure loss and the concentration of organic substances with the elapsed days.

FIG. 4 is a schematic diagram of a desalination treatment system according to a fourth embodiment.

FIG. 5-1 is a diagram illustrating an operation state of a filtration device of the fourth embodiment.

FIG. 5-2 is a diagram illustrating an operation state of a filtration device of the fourth embodiment.

FIG. 5-3 is a diagram illustrating an operation state of a filtration device of the fourth embodiment.

FIG. 6 is a schematic diagram of a desalination treatment system according to a fifth embodiment.

### DESCRIPTION OF EMBODIMENTS

Hereinafter, the present invention will be described in detail with reference to the drawings. Incidentally, the present invention is not limited to the following embodiments. In addition, the constituent elements in the following embodiments include those that can easily be assumed by those skilled in the art, those that are substantially the same, and so-called equivalents. Furthermore, the constituent elements disclosed in the following embodiments can be appropriately combined.

### First Embodiment

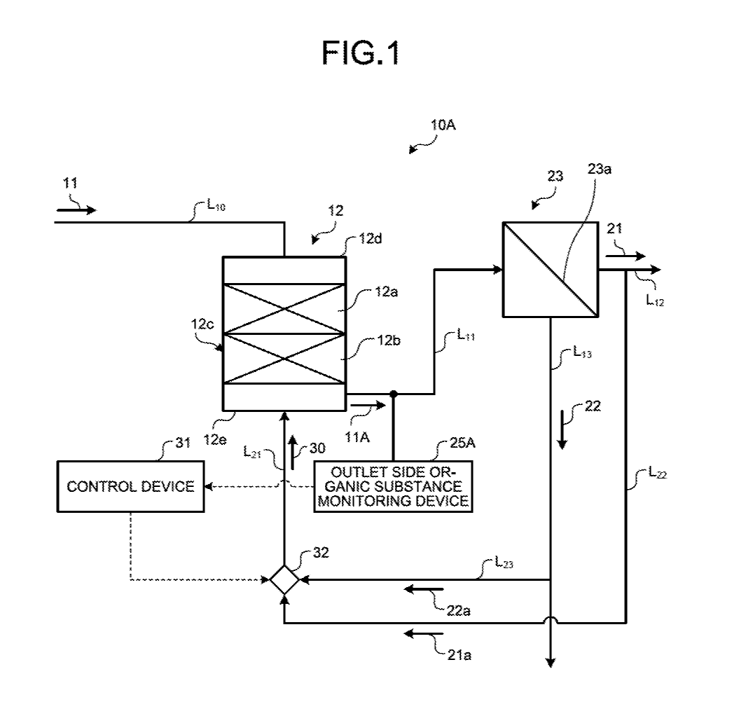

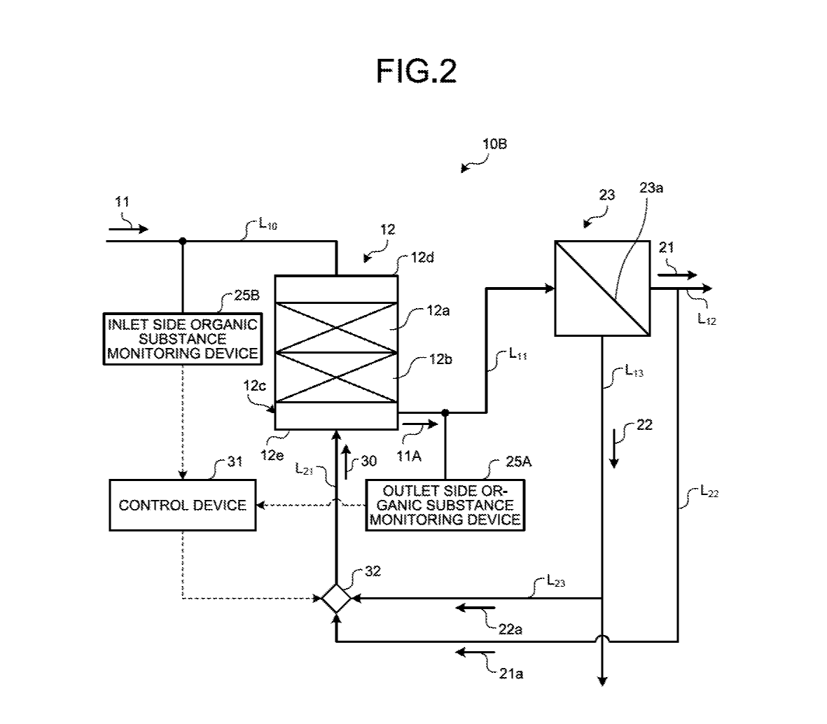

Filtration treatment systems of raw water according to embodiments of the present invention will be described with reference to the drawings. Hereinafter, a desalination treatment system will be described by taking a desalination device equipped with a separation membrane which enriches a solute such as a salt or fine particles as an example of a separation device in the present embodiment. FIG. 1 is the schematic diagram of a desalination treatment system according to a first embodiment. FIG. 2 is the schematic diagram of another desalination treatment system according to the first embodiment.

As illustrated in FIG. 1, a desalination treatment system 10A according to the present embodiment is equipped with a raw water supply line L₁₀ that supplies raw water 11, a filtration device 12 that is provided on the raw water supply line L₁₀ and filters impurities in the raw water 11, a salt concentrator 23 that is provided on a rear side of the filtration device 12 and equipped with a separation membrane 23a to separate filtered raw water 11A into permeated water 21 and concentrated water 22 in which a solute including a salt or fine particles are enriched, and an outlet side organic substance monitoring device 25A that is provided on a rear side of the filtration device 12 and monitors an amount of an organic substance in the raw water 11, and a part 21a of the permeated water 21 is used for backwashing of the filtration device 12 in a case in which an amount of an organic substance in the raw water 11 is determined to exceed a reference value (threshold value) as a result of monitoring by this organic substance monitoring device 25A.

In FIG. 1, a reference sign 31 illustrates a control device, a reference sign 32 illustrates a flow path switching unit, a reference sign L₁₁ illustrates a filtered raw water supply line which supplies the raw water 11A filtered by the filtration device 12 to the salt concentrator 23, a reference sign L₁₂ illustrates a permeated water line which discharges the permeated water 21 from the salt concentrator 23, a reference sign L₁₃ illustrates a concentrated water line which discharges the concentrated water 22 from the salt concentrator 23, a reference sign L₂₁ illustrates a backwashing water supply line, a reference sign L₂₂ illustrates a permeated water branch line that is connected to the backwashing water supply line L₂₁ by the flow path switching unit 32 and branches the part 21a of the permeated water 21 from the permeated water line L₁₂, and a reference sign L₂₃ illustrates a concentrated water branch line that is connected to the backwashing water supply line L₂₁ by the flow path switching unit 32 and branches a part 22a of the concentrated water 22 from the concentrated water line L₁₃, respectively.

Here, the raw water 11 of the present invention is, for example, water to be treated that is subjected to a water treatment by the separation device 23 using a separation membrane such as an ultrafiltration membrane (UF membrane), a nanofiltration membrane (NF membrane), and a reverse osmosis membrane (RO membrane), and examples thereof may include seawater, mine wastewater, and cooling tower wastewater.

The organic substance contained in this raw water 11 is a water-soluble polymer, and it also includes, for example, those caused by metabolism of microorganisms or the like, and examples thereof may include neutral polysaccharides. The molecular weight of this neutral polysaccharide is, for example, 10,000 or more, but it may exceed, for example, one million, or it may exceed, for example, ten millions. In addition, there is also a case in which a polymer component having a molecular weight of 10,000 or less is included.

Here, in the case of installing the outlet side organic substance monitoring device 25A of the filtration device 12, inorganic substance-based impurities are captured by the filtration layers 12a and 12b of the filtration device 12, and it is thus possible to ascertain the amount of organic substance-based impurities.

In the filtration device 12, a carbon-based material such as anthracite is used as the filtration layer 12a on the upper layer side, a granular filter medium such as silica sand is used as the filtration layer 12b of a lower layer, the filtration layers 12a and 12b provided in a filtration device main body 12c by being layered, and the raw water 11 is introduced from a top portion 12d side and passes through the filtration layers 12a and 12b so that the suspended solids in the raw water 11 are captured.

Here, as the organic substance monitoring device of the present invention, it is possible to use an organic substance concentration meter which directly measures the concentration of organic substances in the raw water 11 and a turbidity measuring device which indirectly measures the concentration of organic substances.

Examples of the organic substance concentration meter may include a total organic carbon (TOC) meter, an ultraviolet visible spectrophotometer, COD (Chemical Oxygen Demand), and SFF (Soluble Fouling Factor. For example, see Japanese Laid-open Patent Publication No. 2012-213676). Incidentally, the measurement may be either online automatic measurement or analysis by sampling.

Here, in the case of taking the TOC meter as an example, it is desirable that the reference value of the TOC concentration is, for example, 2 mg/kg or more, preferably 2.5 mg/kg or more, and more preferably 3 mg/kg or more.

Moreover, the part 21a of the permeated water 21 is introduced from a bottom portion 12e of the filtration device 12 as a backwashing water 30 to perform backwashing when the concentration of organic substances is determined to exceed the reference value as a result of measurement by the organic substance concentration meter.

In other words, in the case of using an organic substance concentration meter as the outlet side organic substance monitoring device 25A, backwashing is carried out by using the part 21a of the permeated water 21 as the backwashing water 30 in a case in which the concentration of organic substances in the raw water 11 exceeds the reference value, but the control device 31 determines and switches the flow path by the flow path switching unit 32 and backwashing is carried out by using the part 22a of the concentrated water 22 for backwashing of the filtration device 12 in a case in which the concentration of organic substances is equal to or less than the reference value.

In the related art, washing has been performed always by using fresh water as the backwashing water 30 when backwashing is carried out when there is an increase in pressure loss in the filtration device.

In contrast, in the present embodiment, only in a case in which the amount of organic substances in the raw water 11 is determined to exceed the reference value as a result of measurement by the outlet side organic substance monitoring device 25A, the control device 31 instructs the flow path switching unit 32 to change the flow path so that the fresh water of the part 21a of the permeated water 21 becomes the backwashing water 30, and the part 21a of the permeated water 21 is introduced from the bottom portion 12e of the filtration device 12, and backwashing is performed, and it is thus possible to decrease the amount of permeated water used when carrying out backwashing.

In addition, as the turbidity measuring device which measures the amount of organic substances, it is preferable to use the SDI value (Silt Density Index) prescribed in ASTM D4189, the FI value (Fouling Index) prescribed in JIS K 3802, and the like.

Here, in the case of measuring the amount of organic substances by using a turbidity measuring device as the outlet side organic substance monitoring device 25A, the turbidity measuring device is required to be provided on the rear side of the filtration device 12. This is because there are turbidity causing materials which are mostly composed of inorganic substances and turbidity causing materials which are mostly composed of organic substances as the turbidity causing materials which are contained in the raw water 11. Moreover, the turbidity causing materials which are mostly composed of inorganic substances removed by introducing the raw water 11 into the filtration device 12, and the turbidity causing materials in the filtered raw water 11A on the rear side are measured and regarded as the turbidity causing materials which are mostly composed of organic substances.

In a case in which SDI is used as an index to measure the turbidity causing materials, the backwashing water 30 to be used in backwashing is switched from the concentrated water 22 of seawater to freshwater of the permeated water 21 by the flow path switching unit 32 in a case in which SDI measured at the downstream of the outlet of the filtration device 12 is equal to or more than the reference value (for example, 3 or more, or 3.5 or more, or even 6 or more).

In this manner, in the present embodiment, backwashing is performed by using fresh water of a part 21a of the permeated water 21 regardless of the value of pressure loss in a case in which the concentration of organic substances is increased to be equal to or more than the reference value as a result of measurement by the outlet side organic substance monitoring device 25A.

Incidentally, in the related art, it is controlled such that backwashing is performed based on an increase in pressure loss, but in the present embodiment, only a change in pressure loss is not taken into consideration, but when the amount of organic substances is equal to or more than the reference value, it is determined that there is an influence by the organic substances, and backwashing is carried out by using fresh water of the part 21a of the permeated water 21.

Incidentally, there is a case in which contamination of the filtration layers 12a and 12b of the filtration device 12 occurs in a case in which seawater at the inlet is dirty although the pressure loss does not increase, that case corresponds to a case in which the pretreatment function of the filtration device 12 cannot be sufficiently exerted, and it is thus possible to prevent filtering clogging and the like in advance by carrying out washing through backwashing before the function of the filtration device 12 is greatly decreased by the pressure loss.

In this manner, it is possible to quickly remove dirt due to the organic substances of the filter medium and to maintain the organic substance removal performance by the filtration device 12 by controlling the washing timing of backwashing based on the amount of organic substances in seawater but not by the pressure loss in the related art.

In particular, the amount of organic substances to be adsorbed to the filter medium also increases by adsorption equilibrium as the concentration of organic substances in seawater of the raw water 11 increases. Thereafter, the adsorbed organic substances desorb more than usual in a case in which the concentration of organic substances in seawater decreases, and the concentration of organic substances in seawater on the outlet side is thus increased more than on the inlet side in some cases. For that reason, it is required to promote particularly the removal of organic substances through backwashing using fresh water after the concentration of organic substances in seawater is increased.

According to the present embodiment, a part of the permeated water is not always used at the time of backwashing by using a part of the permeated water for backwashing in a case in which the concentration of organic substances exceeds the reference value, and it is thus possible to efficiently perform recovery of the filtration performance by removing the organic substances of the filtration device while suppressing the amount of the permeated water used.

In the present embodiment, as a device which monitors this concentration of organic substances, the outlet side organic substance monitoring device 25A of the filtration device 12 is installed, but the present invention is not limited thereto.

Specifically, as illustrated in a desalination treatment system 10B of FIG. 2, it is also possible to monitor the amount of organic substances attached to the filtration device 12 by installing an inlet side organic substance monitoring device 25B and the outlet side organic substance monitoring device 25A.

In addition, in the case of being illustrated in FIG. 2, only the inlet side organic substance monitoring device 25B may be installed on the inlet side of the filtration device 12.

In this manner, according to the present embodiment, by a method of washing the filtration device 12 by removing suspended solids and the like in the raw water, including monitoring step of monitoring the organic substances in the raw water 11, and washing the filtration device 12 by using a part of the permeated water 21 obtained by removing the concentrated water 22 in which a solute such as a salt or fine particles are enriched from the filtered raw water for backwashing in a case in which the organic substances in the raw water 11 exceed the reference value, a part of the permeated water 21 is not always used at the time of backwashing, and it is thus possible to efficiently perform recovery of the filtration performance by removing the organic substances of the filtration device 12 while suppressing the amount of the permeated water 21 used.

In the present embodiment, the filtration treatment system of raw water has been described by taking a desalination treatment system for seawater desalination in which a solute such as a salt or fine particles are enriched as an example, but the present invention is not limited thereto, and the filtration treatment system of raw water can also be applied to water treatment systems, for example, a sewage treatment for removing fine particles in raw water and a wastewater treatment of brackish water (water in which seawater and fresh water are mixed and the amount of salts is smaller than in seawater; brackish water)

In the present embodiment, washing of the filtration device 12 is performed by using the permeated water 21 and the concentrated water 22 which are separated by the separation device 23, but raw water may also be used as long as it is raw water which can be applied for backwashing.

### Second Embodiment

The method of backwashing a filtration device of a desalination treatment system according to embodiments of the present invention will be described with reference to the drawings. Incidentally, in the present embodiment, it is described based on the desalination treatment system 10A illustrated in FIG. 1. FIGS. 3-1 and 3-2 are diagrams which illustrate the relation of the pressure loss and the concentration of organic substances with the elapsed days.

In the first embodiment, the part 21a of the permeated water 21 of fresh water is used as the backwashing water 30 in a case in which backwashing is carried out based on the concentration of organic substances without considering the pressure loss in the filtration device 12.

In contrast, in the present embodiment, the backwashing water 30 is switched from the concentrated water 22 of seawater to the permeated water 21 of fresh water after a certain period of time has elapsed even in a case in which the concentration of organic substances in seawater of the raw water 11 does not increase to be equal to or more than the reference value (threshold value).

Here, the set period to switch the backwashing water can be appropriately changed depending on the quality of seawater of the raw water 11, and for example, it can be prescribed as every day, every other day, every week, every two weeks, every month, and the like.

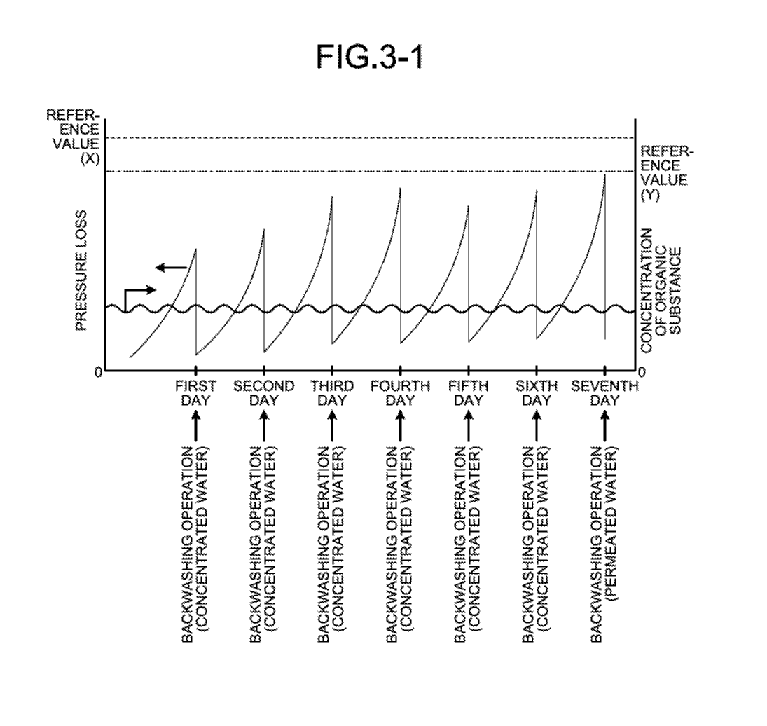

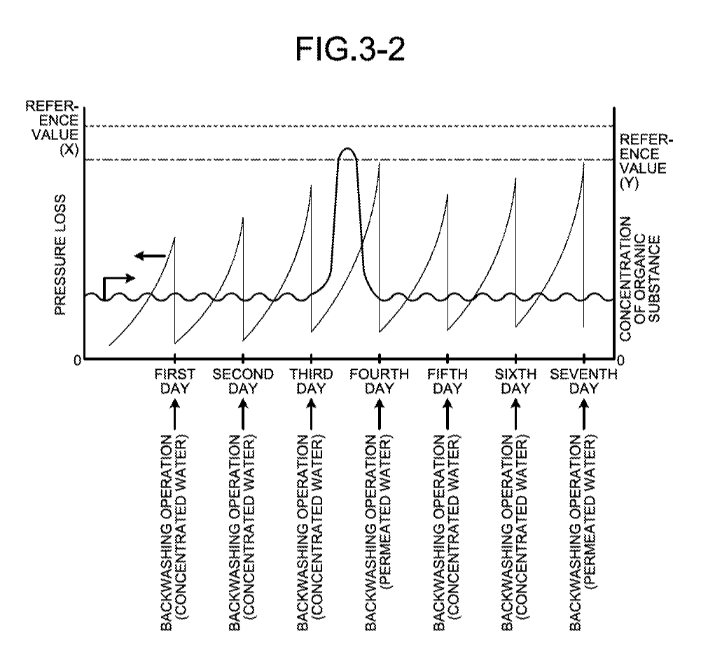

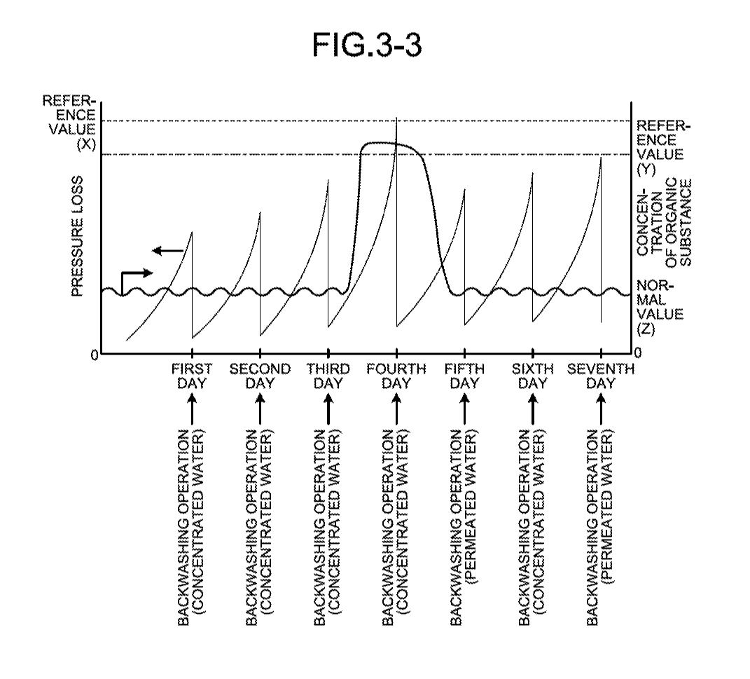

FIG. 3-1 illustrates an example of the switching operation of backwashing water to be used at the time of backwashing for one week in the diagram illustrating the relation of the pressure loss and the concentration of organic substances with the elapsed days. In FIG. 3-1, the left vertical axis shows the pressure loss, and the reference value (X) is prescribed. The right vertical axis shows the concentration of organic substances, and the reference value (Y) is prescribed.

In addition, as the interval of backwashing, backwashing may be regularly carried out, backwashing may be carried out when the pressure loss exceeds the reference value, or both of them may be concurrently used, and any of them may be employed.

In the operation in FIG. 3-1, it is a case in which backwashing is carried out one time a day at every predetermined time, and in the operation, the concentrated water 22 is used as the backwashing water 30 from the first day to the sixth day, and the permeated water 21 is used as the backwashing water 30 on the seventh day.

Here, in the operation of FIG. 3-1, the pressure loss and the concentration of organic substances are lower than the reference values (X and Y), and backwashing by the permeated water 21 is thus performed on the seventh day for the first time. Thereafter, backwashing by the permeated water 21 is performed on every seventh day regardless of the value of pressure loss.

According to the present invention, the amount of organic substances adsorbed to the filtration layers 12a and 12b of the filtration device 12 gradually increases even in a case in which the amount of the organic substances in the raw water 11 does not remarkably increase, and thus the organic substances on the filtration layers 12a and 12b are removed and the accumulation of organic substances is suppressed by performing backwashing by using the part 21a of the permeated water 21 when a certain period of time elapses.

In contrast, in an example illustrated in FIG. 3-2, it is a case in which the concentration of organic substances exceeds the reference value (Y) on the third day through monitoring by the outlet side organic substance monitoring device 25A, and in the backwashing operation on the fourth day, backwashing is carried out by using the permeated water 21 as the backwashing water 30.

### Third Embodiment

The method of backwashing a filtration device of a desalination treatment system according to embodiments of the present invention will be described with reference to the drawings. Incidentally, in the present embodiment, it is described based on the desalination treatment system 10A illustrated in FIG. 1. FIG. 3-3 is a diagram which illustrates the relation of the pressure loss and the concentration of organic substances with the elapsed days.

In the present embodiment, as illustrated in FIG. 3-3, it is assumed a case in which the concentration of organic substances does not immediately decrease in a case in which the concentration of organic substances in the raw water 11 is increased.

In such a case, backwashing is not carried out until the concentration of organic substances decreases after the concentration is increased through monitoring by the outlet side organic substance monitoring device 25A, and washing is performed by using fresh water of the part 21a of the permeated water 21 when the concentration of organic substances is decreased to be equal to or less than the normal reference (Z).

Specifically, as illustrated in FIG. 3-3, in a case in which the concentration of organic substances is equal to or more than the reference value (Y) on the fourth day and it continues until the fifth day, when an increase in pressure loss is equal to or more than the reference value (X), backwashing is performed by using the fresh water of the part 21a of the permeated water 21 as the backwashing water 30 in the case of a second embodiment, but backwashing is carried out by using a part 22a of the concentrated water 22 without using fresh water of the part 21a of the permeated water 21 as the backwashing water 30 in the case of the present embodiment.

Moreover, backwashing is carried out by using fresh water of the part 21a of the permeated water 21 as the backwashing water 30 in a case in which the concentration of organic substances decreases to be equal to or less than the normal value (Z) in the middle of the fifth day.

Incidentally, backwashing is carried out by using a part 22a of the concentrated water 22 as the backwashing water 30 on the fifth day as well in a case in which the concentration of organic substances does not decrease to be equal to or less than the normal value (Z) even on the fifth day.

The filtration layer of the filtration device 12 is contaminated immediately in the case of restarting the operation after backwashing is performed and the backwashing operation is required again even if the backwashing operation is carried out in a state in which the concentration of organic substances in the raw water 11 is still high. Hence, as in the present embodiment, it is possible to save the amount of permeated water 21 used and to perform effective washing by continuously performing the operation as it is and using the concentrated water for backwashing in a case in which the concentration of organic substances in the raw water 11 exceeds the reference value (Y) and the state continues for a predetermined time and by performing backwashing by using the permeated water 21 after it is detected that the concentration of organic substances in the raw water 11 is decreased to be equal to or less than the reference value (Y) of the threshold value.

### Fourth Embodiment

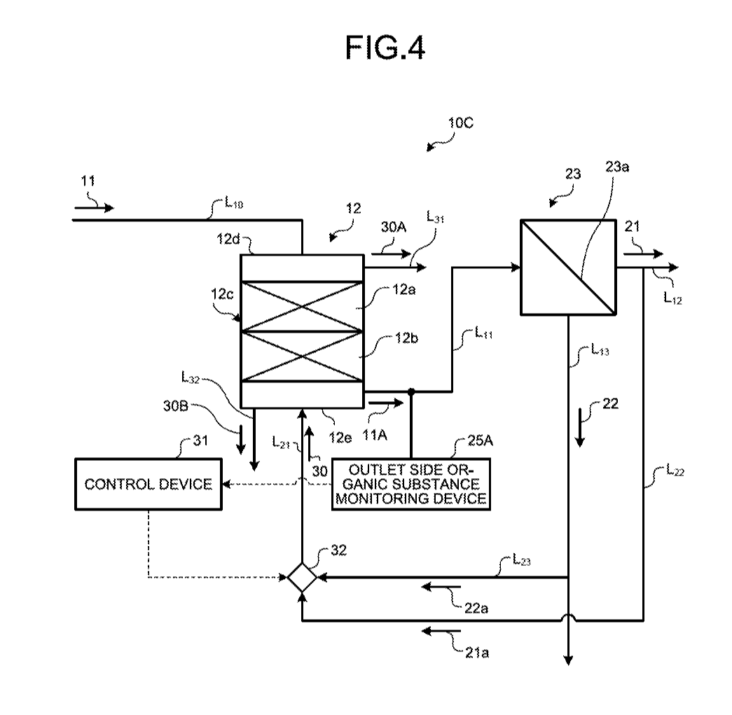

The desalination treatment system according to embodiments of the present invention will be described with reference to the drawings. FIG. 4 is the schematic diagram of a desalination treatment system according to the fourth embodiment. FIGS. 5-1 to 5-3 are diagrams which illustrate the operation states of the filtration device of the fourth embodiment.

A desalination treatment system 10C of the present embodiment has the same device configuration as that of the desalination treatment system 10A of FIG. 1, but it is provided with a discharge mechanism of backwashing water when backwashing the filtration device.

As illustrated in FIG. 4, the filtration device 12 according to the present embodiment is equipped with the filtration device main body 12c having a plurality of filtration layers 12a and 12b layered in the vertical axis direction in the interior, a raw water supply line L₁₀ that is connected to the top portion 12d of the filtration device main body 12c and supplies the raw water 11 from this top portion 12d side, a filtered raw water supply line L₁₁ that is connected to the bottom portion 12e of the side wall of the filtration device main body 12c, discharges the raw water 11A filtered from this side wall side and supplies the raw water 11A to the salt concentrator 23, a backwashing water supply line L₂₁ that is connected to the bottom portion 12e of the filtration device main body 12c and introduces the backwashing water 30 from this the bottom portion 12e side, an overflow line L₃₁ that is connected to the top portion 12d side of the side wall of the filtration device main body 12c and discharges the backwashing water 30 from the top portion 12d side of the filtration layer 12a as an overflowed water 30A, and a backwashing water discharge line L₃₂ that is connected to the bottom portion 12e of the filtration device main body 12c and discharges a backwashing water 30B which cannot overflow from this bottom portion 12e side.

As illustrated in FIGS. 5-1 to 5-3, in the filtration device 12 according to the present embodiment, the raw water 11 is introduced from the top portion 12d of the filtration device main body 12c through the raw water supply line L₁₀. The control device 31 controls the introduction of the raw water 11 into the filtration device main body 12 by controlling a valve V₁₀ provided on the raw water supply line L₁₀.

In addition, the filtered raw water 11A is discharged from the bottom portion 12e side of the filtration device main body 12c through the filtered raw water supply line L₁₁. The control device 31 controls the discharge of the filtered raw water 11A from the filtration device 12c by controlling a valve V₁₁ provided on the filtered raw water supply line L₁₁.

In addition, the backwashing water 30 is introduced from the bottom portion 12e side of the filtration device main body 12c through the backwashing water supply line L₂₁. The control device 31 controls the introduction of the backwashing water 30 into the filtration device main body 12c by controlling a valve V₁₂ provided on the backwashing water supply line L₂₁.

In addition, the overflowed water 30A is discharged from the top portion 12d side of the filtration layer 12a of the filtration device main body 12c through the overflow line L₃₁. The control device 31 controls the discharge of the overflowed water 30A which has flowed into the overflow line L₃₁ by controlling a valve V₁₃ provided on the overflow line L₃₁.

Furthermore, the backwashing water 30B which cannot overflow is discharged from the bottom portion 12e side of the filtration device main body 12c through the backwashing water discharge line L₃₂. The control device 31 controls the discharge and storage of the backwashing water 30B which cannot overflow, namely, the backwashing water 30B stored in the region on the vertically lower side of the overflow line L₃₁ of the filtration device main body 12 by controlling the opening and closing of a valve V₁₄ provided on the backwashing water discharge line L₃₂.

### Normal Operation

The normal operation of the present embodiment is a case in which the raw water 11 is filtered by the filtration device 12.

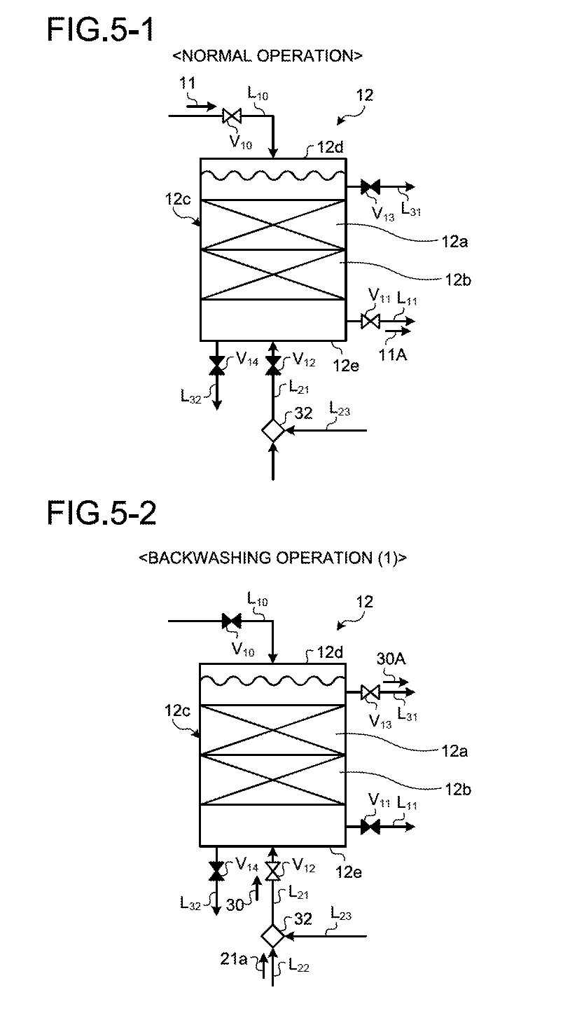

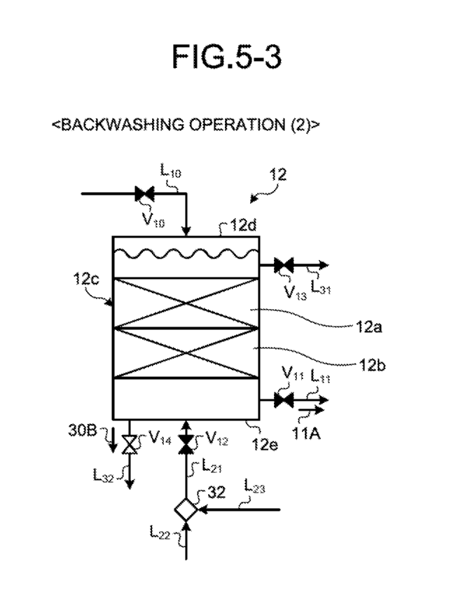

In the case of this normal operation, as illustrated in FIG. 5-1, the control device 31 controls the valves V₁₀ and V₁₁ to open and the valves V₁₂, V₁₃, and V₁₄ to close. In the desalination treatment system 10C, the raw water 11 is introduced into the filtration device main body 12c and the suspended substances in the raw water 11 are captured by the filtration layers 12a and 12b. Incidentally, in FIG. 5-1, FIG. 5-2, and FIG. 5-3, the black mark of valve is a case in which the valve is closed and the white mark of valve is a case in which the valve is open.

### Backwashing Operation (1)

Next, as illustrated in FIG. 5-2, a backwashing operation is executed when it is determined that the concentration of organic substances in the raw water 11 exceeds the reference value by the outlet side organic substance monitoring device 25A.

In the case of this backwashing operation, the control device 31 controls the valves V₁₂ and V₁₃ to open and the valves V₁₀, V₁₁, and V₁₄ to close and thus stops the introduction of the raw water 11.

Moreover, as the backwashing water 30, the flow path switching unit 32 is switched so that a part 21a of the permeated water 21 is introduced from the bottom portion 12e of the filtration device main body 12c. The introduced backwashing water 30 is discharged to the outside as the overflowed water 30A through the overflow line L₃₁ on the upper side of the filtration layer 12a, and backwashing is performed.

### Backwashing Operation (2)

Thereafter, as illustrated in FIG. 5-3, the introduction of the backwashing water 30 is stopped, and the control device 31 controls the valves V₁₀, V₁₁, V₁₂, and V₁₃ to close and the valve V₁₄ to open. The desalination treatment system 10C discharges the backwashing water 30B which cannot overflow and thus remains in the filtration device main body 12c through the backwashing water discharge line L₃₂ and drains the backwashing water 30B which is in the interior of the filtration device main body 12c and cannot overflow.

According to the present embodiment, it is possible to decrease the concentration of organic substances in the washing water and to improve the washing effect when the interior of the filtration device 12 is washed by once discharging the backwashing water 30B which is contaminated with the organic substances in the filtration device 12 and cannot overflow and then supplying the permeated water 21.

This operation that the backwashing water 30B is drained, water in the interior of the filtration device main body 12c is drained, then the backwashing water 30 is introduced again to perform backwashing, and the water is drained again may be repeated at least one time or more.

### Fifth Embodiment

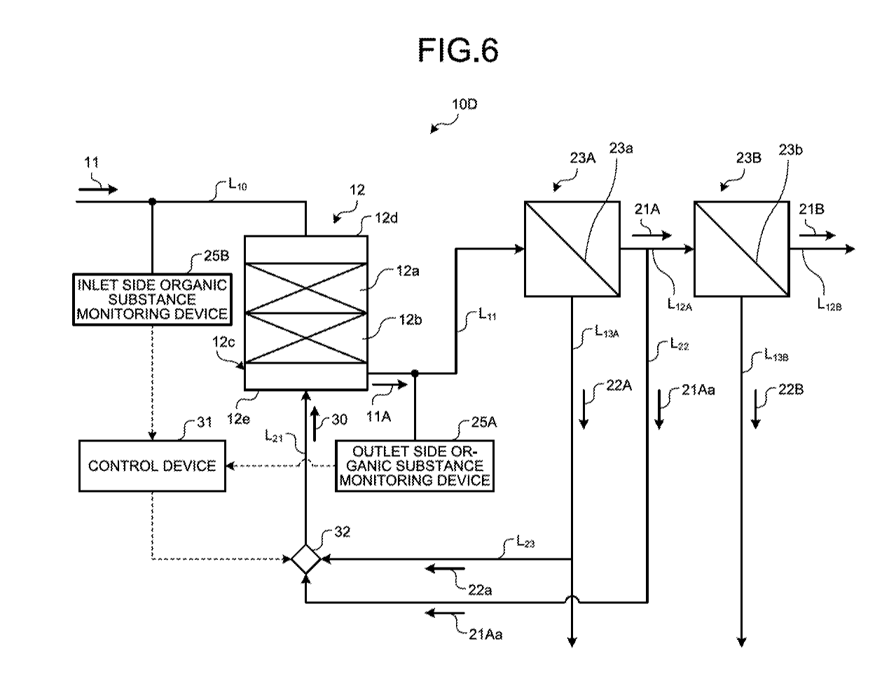

The method of backwashing a filtration device of a desalination treatment system according to embodiments of the present invention will be described with reference to the drawings. FIG. 6 is the schematic diagram of a desalination treatment system according to the present embodiment.

A desalination treatment system 10D illustrated in FIG. 6 is provided with the salt concentrator 23 having a plurality of stages (a first salt concentrator 23A, a second salt concentrator 23B, . . . ) in series in the desalination treatment system 10A of the first embodiment.

In the present embodiment, as illustrated in FIG. 6, the first salt concentrator 23A is provided at the subsequent stage of the filtration device 12 and the second salt concentrator 23B is provided at the subsequent stage of the first salt concentrator 23A. Moreover, the raw water 11A filtered by the filtration device 12 is first introduced into the first salt concentrator 23A and separated into a permeated water 21A and a concentrated water 22A in which a solute such as a salt or fine particles are enriched by the separation membrane 23a of the first salt concentrator 23A. Next, the separated permeated water 21A is introduced into the second salt concentrator 23B through the permeated water line L_{12A} and the separated into a permeated water 21B and a concentrated water 22B in which a solute such as a salt or fine particles are enriched by the separation membrane 23b of the second salt concentrator 23B. The permeated water 21B separated by the separation membrane 23b of the second salt concentrator 23B is discharged through the permeated water line L_{12B} and utilized as produced water (fresh water).

Moreover, in the present embodiment, backwashing of the filtration device 12 is performed by using a part 21Aa of the permeated water 21A from the (leading) first salt concentrator 23A on the filtration device 12 side.

As a result, it is possible to obtain a sufficient backwashing effect, for example, without relatively decreasing the fresh water production efficiency in a desalination plant to desalinate seawater by using the part 21Aa of the permeated water 21A of the first salt concentrator 23A as the backwashing water 30 without using the permeated water 21B of fresh water manufactured by the salt concentrator at the final stage as the backwashing water 30 to be used for backwashing.

Here, when the desalination treatment is performed by using seawater as the raw water 11, about 90% or more of the organic substances in the seawater is removed when the seawater passes through the first salt concentrator 23A, and a sufficient backwashing effect can be thus obtained even when a part 21Aa of the permeated water 21A of the first salt concentrator 23A is utilized as the backwashing water 30.

Accordingly, it is possible to save the power required for treating the water to be used for backwashing by the second salt concentrator 23B or the subsequent salt concentrator by using the part 21Aa of the permeated water 21A from the first salt concentrator 23A instead of the finally manufactured fresh water, and the operation efficiency of the desalination plant for seawater is thus improved.

According to the present embodiment, in a case in which a plurality of salt concentrators 23 (the first salt concentrator 23A, the second salt concentrator 23B, . . . ) to obtain permeated water are installed in series to improve the desalination performance, it is possible to obtain a sufficient backwashing effect without relatively decreasing the treatment efficiency of the salt concentration plant by using a part 21Aa of the permeated water 21A from the first salt concentrator 23A that is on the leading side and has a relatively low salt removal rate instead of using permeated water of the final product as the permeated water to be used for backwashing.

In the present embodiment, two salt concentrators are illustrated, but in the case of installing a plurality of stages of three or more, it is preferable to perform backwashing of the filtration device 12 by using permeated water from a separation device (for example, the separation device at the first or second stage in a case in which three separation devices are installed in series) provided on the upstream side of a separation device other than the separation device (separation device at the final stage) provided at the position farthest from the filtration device 12.

In addition, in the case of installing three or more salt concentrators 23 in series, a part of the permeated water 21B or the like from the second or subsequent salt concentrator 23B or the like from the filtration device 12 side is also used in some cases in consideration of the concentration of organic substances and the like.

### REFERENCE SIGNS LIST

10A to 10D DESALINATION TREATMENT SYSTEM

11 RAW WATER

12 FILTRATION DEVICE

21 PERMEATED WATER

22 CONCENTRATED WATER

23 SALT CONCENTRATOR

23A FIRST SALT CONCENTRATOR

23B SECOND SALT CONCENTRATOR

25A OUTLET SIDE ORGANIC SUBSTANCE MONITORING DEVICE

25B INLET SIDE ORGANIC SUBSTANCE MONITORING DEVICE

1-12. (canceled)

13. A filtration treatment system of raw water comprising:
a raw water supply line that is configured to supply raw water;
a filtration device that is provided on the raw water supply line and configured to filter impurities in the raw water;
a separation device that is provided on a downstream side of the filtration device and equipped with a separation membrane to separate filtered raw water into permeated water and concentrated water in which a solute including a salt or fine particles are enriched;
an organic substance monitoring device that is provided on either an upstream side or a downstream side or both the upstream side and the downstream side of the filtration device and configured to monitor an amount of an organic substance in the raw water; and
a control device that is configured to execute backwashing of the filtration device with the raw water or the concentrated water as the backwashing water in a case in which the amount of the organic substance in the raw water is equal to or less than the reference value as a result of monitoring by the organic substance monitoring device.

14. The filtration treatment system of raw water according to claim 13, wherein the organic substance monitoring device includes an organic substance concentration measurement device configured to measure a concentration of the organic substance in the raw water.

15. The filtration treatment system of raw water according to claim 13, wherein the organic substance monitoring device is provided on a downstream side of the filtration device and includes a turbidity measuring device configured to measure a turbidity in raw water from the filtration device.

16. The filtration treatment system of raw water according to claim 13, wherein the control device executes backwashing of the filtration device with the permeated water at every set period.

17. The filtration treatment system of raw water according to claim 13, comprising:
a plurality of the separation devices, wherein
the plurality of separation devices are connected to permeated water lines to discharge the permeated water in series,
the filtration device is connected to a permeated water line of permeated water to be discharged from the separation device provided on an upstream side of the separation device at a final stage, and
the control device performs backwashing of the filtration device with permeated water to be discharged from the separation device provided on the upstream side of the separation device at the final stage in a case of executing backwashing of the filtration device with the permeated water.

18. The filtration treatment system of raw water according to claim 13, wherein the filtration device includes:
a filtration device main body that has a plurality of filtration layers layered in a vertical axis direction in an interior;
a raw water supply line that is configured to supply the raw water from a top portion side of the filtration device main body;
a filtered raw water supply line that is configured to discharge filtered raw water filtered from a bottom portion side of the filtration device main body and supply the filtered raw water to the separation device;
a backwashing water introduction line that is configured to introduce backwashing water from the bottom portion side of the filtration device main body;
an overflow line that is configured to collect the backwashing water overflowed from a top portion side of the filtration layers of the filtration device main body; and
a backwashing water discharge line that is configured to discharge the backwashing water of the interior of the filtration device main body from the bottom portion side of the filtration device main body.

19. The filtration treatment system of raw water according to claim 18, wherein the control device executes backwashing of the filtration device by carrying out a treatment in which the backwashing water discharge line is opened, the backwashing water in an interior of the filtration device main body is drained through the backwashing water discharge line, then the backwashing water discharge line is closed, and the backwashing water is introduced into the interior of the filtration device main body through the backwashing water introduction line at least once or more.

20. The filtration treatment system of raw water according to claim 13, wherein
the control device executes backwashing with the permeated water after the concentration of the organic substance is decreased to a concentration equal to or less than a threshold concentration lower than a predetermined concentration
in a case in which a state in which the concentration of the organic substance exceeds the predetermined concentration continues for a predetermined time or longer through monitoring by the organic substance monitoring device.

21. A method of washing a filtration device that is configured to remove a suspended solid in raw water, the method comprising:
an organic substance monitoring step of monitoring an amount of an organic substance in the raw water; and
a step of performing backwashing of the filtration device by using the raw water or concentrated water in which a solute including a salt or fine particles are enriched in the raw water as backwashing water in a case in which an amount of an organic substance in the raw water is equal to or less than a reference value, and performing backwashing of the filtration device by using permeated water that the raw water is filtered as the backwashing water in a case in which the amount of the organic substance in the raw water exceeds the reference value as a result of the organic substance monitoring step.
